(19) United States
(12) Patent Application Publication
(10) Pub. No.: US 2025/0373992 A1
(43) Pub. Date: Dec. 4, 2025

(54) HEARING DEVICE CONFIGURED TO CLEAR A LIQUID FROM AN ACOUSTIC PATHWAY OF THE DEVICE

(71) Applicant: Starkey Laboratories, Inc., Eden Prairie, MN (US)

(72) Inventors: Kenneth R. Ostrin, Portland, OR (US); Meredith McLinn, St Louis Park, MN (US); Denise Klokow, Faribault, MN (US); Viktor Klymko, Minneapolis, MN (US)

(21) Appl. No.: 19/176,995

(22) Filed: Apr. 11, 2025

Related U.S. Application Data
(60) Provisional application No. 63/653,456, filed on May 30, 2024.

(51) Int. Cl. H04R 25/00; B08B 7/02

(52) U.S. Cl. CPC H04R 25/604; B08B 7/026

(57) ABSTRACT

A hearing device comprises a controller, audio circuitry coupled to the controller, and an acoustic transducer coupled to the audio circuitry. The acoustic transducer is fluidically coupled to an acoustic pathway between the acoustic transducer and an exterior surface of the hearing device. The controller is configured to activate the acoustic transducer to cause vibration in the hearing device and generate positive pressure within the acoustic pathway sufficient to clear liquid from the acoustic pathway.

### CROSS-REFERENCE TO RELATED APPLICATIONS

This application claims the benefit of U.S. Provisional Application No. 63/653,456 filed May 30, 2024, the content of which is incorporated herein by reference in its entirety.

### TECHNICAL FIELD

This application relates generally to ear-level electronic systems and devices, including hearing devices, personal amplification devices, hearing aids, hearables, and other ear-worn electronic devices.

### SUMMARY

Embodiments are directed to a method of clearing a liquid from an acoustic pathway of a hearing device. The method comprises activating an acoustic transducer of the hearing device to cause vibration in the hearing device and generate positive pressure within the acoustic pathway, and clearing the liquid from the acoustic pathway in response to the vibration and the positive pressure.

Embodiments are directed to a hearing device comprising a controller, audio circuitry coupled to the controller, and an acoustic transducer coupled to the audio circuitry. The acoustic transducer is fluidically coupled to an acoustic pathway between the acoustic transducer and an exterior surface of the hearing device. The controller is configured to activate the acoustic transducer to cause vibration in the hearing device and generate positive pressure within the acoustic pathway sufficient to clear liquid from the acoustic pathway.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 is a block diagram of a hearing device configured to implement a procedure for clearing a liquid from an acoustic pathway of the hearing device in accordance with any of the embodiments disclosed herein;

FIG. 2 illustrates a series of sound waves generated by the hearing device shown in FIG. 1 when implementing a liquid clearing procedure in accordance with any of the embodiments disclosed herein.

FIG. 3 is a flow diagram of a method for clearing a liquid from an acoustic pathway of a hearing device in accordance with any of the embodiments disclosed herein.

FIG. 4 is a flow diagram of a method for clearing a liquid from an acoustic pathway of a hearing device in accordance with any of the embodiments disclosed herein.

FIG. 5 is a flow diagram of a method for clearing a liquid from an acoustic pathway of a hearing device in accordance with any of the embodiments disclosed herein.

FIG. 6 is a flow diagram of a method for clearing a liquid from an acoustic pathway of a hearing device in accordance with any of the embodiments disclosed herein.

FIG. 7 is a flow diagram of a method for clearing a liquid from an acoustic pathway of a hearing device in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

A user of a hearing device can expose the hearing device to a variety of challenging conditions. For example, a hearing device can be exposed to humid environments, sweat, and rain. A waterproof hearing device, for example, can be exposed to water when submersed in a pool, lake, or sea. In these and other scenarios, residual liquid can be present in an acoustic pathway of the hearing device, which can negatively impact the audio performance of the hearing device. For example, audio quality can be negatively impacted by the presence of liquid blocking the path from an acoustic transducer of the hearing device to the user's eardrum. Also, water trapped in the hearing device may leak into the user's ear, leading to discomfort and possible infection.

Normally, a hearing device user might need to wait several hours to allow the hearing device to dry. Moreover, hearing device drying times are unpredictable and inconsistent. In some cases, the user may attempt to remove liquid from the acoustic pathway by shaking the hearing device, which can damage the device.

Embodiments of the disclosure are directed to a hearing device configured to implement a procedure for clearing a liquid from an acoustic pathway of the hearing device. A liquid clearing procedure according to the present disclosure provides a rapid approach to removing a liquid (e.g., water, sweat) from the acoustic pathway of the hearing device. For example, the acoustic pathway of the hearing device can be cleared of liquid as a result of implementing the liquid clearing procedure for seconds or tens of seconds (e.g., 5, 10, 15 or 20 seconds). Even in cases where the liquid clearing procedure is repeated, the procedure can effectively clear liquid from the acoustic pathway of the hearing device in less than one minute.

Representative embodiments of the disclosure are defined in the following Examples. Below there is provided a non-exhaustive listing of non-limiting examples. Any one or more of the features of these examples may be combined with any one or more features of another example, embodiment, or aspect described herein.
Example Ex1. A method of clearing a liquid from an acoustic pathway of a hearing device, comprises activating an acoustic transducer of the hearing device to cause vibration in the hearing device and generate positive pressure within the acoustic pathway, and clearing the liquid from the acoustic pathway in response to the vibration and the positive pressure.
Example Ex2. The method according to Ex1, wherein the acoustic transducer is a receiver, and the acoustic pathway comprises a receiver port extending between the receiver and an external surface of the hearing device.
Example Ex3. The method according to Ex1 or Ex2, comprising clearing, via the vibration, liquid from a microphone port extending between a microphone of the hearing device and an external surface of the hearing device.
Example Ex4. The method according to any one of Ex1 to Ex3, comprising clearing, via the vibration, liquid from a vent of the hearing device.
Example Ex5. The method according to any one of Ex1 to Ex4, comprising producing, by the acoustic transducer, sound waves to generate positive pressure within the acoustic pathway, wherein the sound waves comprise a series of positive-going square waves.
Example Ex6. The method according to Ex5, wherein the square waves have a steep rising slope and a gradual trailing slope.
Example Ex7. The method according to any one of Ex1 to Ex6, wherein the acoustic transducer is activated at a first frequency that substantially matches an audio resonant frequency of the acoustic transducer to generate positive pressure within the acoustic pathway, and activated at a second frequency that substantially matches a vibration resonant frequency of the hearing device to cause the hearing device to vibrate.
Example Ex8. The method according to Ex7, wherein the first frequency ranges from about 1 kHz to about 4 kHz, and the second frequency ranges from about 6 kHz to about 10 kHz.
Example Ex9. The method according to any one of Ex1 to Ex8, wherein the acoustic transducer is activated for a specified duration and at a maximum intensity.
Example Ex10. The method according to Ex9, wherein the specified duration ranges from about 5 seconds to about 10 seconds.
Example Ex11. The method according to any one of Ex1 to Ex10, wherein the hearing device performs an automated measurement to evaluate audio performance of the hearing device following activation of the acoustic transducer.
Example Ex12. The method according to Ex11, comprising repeating the method until satisfactory hearing device performance is achieved.
Example Ex13. The method according to any one of Ex1 to Ex12, comprising sensing whether the hearing device is deployed in an ear of a user of the hearing device, and prohibiting the liquid clearing method in response to sensing that the hearing device is deployed in the user's ear.
Example Ex14. The method according to any one of Ex1 to Ex13, comprising detecting a magnitude of the vibration using a sensor of the hearing device, and adjusting activation of the acoustic transducer to increase the magnitude of the vibration.
Example Ex15. The method according to Ex14, wherein the sensor comprises one of a microphone and an inertial measurement unit of the hearing device.
Example Ex16. A hearing device comprises a controller comprising one or more processors, audio circuitry coupled to the controller, and an acoustic transducer coupled to the audio circuitry, the acoustic transducer fluidically coupled to an acoustic pathway between the acoustic transducer and an exterior surface of the hearing device, wherein the controller is configured to activate the acoustic transducer to cause vibration in the hearing device and generate positive pressure within the acoustic pathway sufficient to clear liquid from the acoustic pathway.
Example Ex17. The device according to Ex16, wherein the acoustic transducer is a receiver, and the acoustic pathway comprises a receiver port extending between the receiver and the exterior surface of the hearing device.
Example Ex18. The device according to Ex16 or Ex17, comprising a microphone fluidically coupled to a microphone port extending between the microphone and the exterior surface of the hearing device, wherein the vibration in the hearing device is sufficient to clear liquid from the microphone port.
Example Ex19. The device according to any one of Ex16 to Ex18, wherein the hearing device comprises a vent, and the vibration in the hearing device is sufficient to clear liquid from the vent.
Example Ex20. The device according to any one of Ex16 to Ex19, wherein the controller is configured to activate the acoustic transducer to produce sound waves comprising a series of positive-going square waves.
Example Ex21. The device according to Ex20, wherein the square waves have a steep rising slope and a gradual trailing slope.
Example Ex22. The device according to any one of Ex16 to Ex21, wherein the controller is configured to activate the acoustic transducer at a first frequency that substantially matches an audio resonant frequency of the acoustic transducer to generate positive pressure within the acoustic pathway, and activate the acoustic transducer at a second frequency that substantially matches a vibration resonant frequency of the hearing device to cause the hearing device to vibrate.
Example Ex23. The device according to Ex22, wherein the first frequency ranges from about 1 kHz to about 4 kHz, and the second frequency ranges from about 6 kHz to about 10 kHz.
Example Ex24. The device according to any one of Ex16 to Ex23, wherein the controller is configured to activate the acoustic transducer for a specified duration and at a maximum intensity.
Example Ex25. The device according to Ex24, wherein the specified duration ranges from about 5 seconds to about 10 seconds.
Example Ex26. The device according to any one of Ex16 to Ex25, wherein the controller is configured to perform an automated measurement to determine audio performance of the hearing device following activation of the acoustic transducer.
Example Ex27. The device according to Ex26, wherein the controller is configured to repeat activation of the acoustic transducer until satisfactory hearing device performance is achieved.
Example Ex28. The device according to any one of Ex16 to Ex27, wherein the hearing device comprises a sensor coupled to the controller, the sensor configured to sense whether the hearing device is deployed in an ear of a user of the hearing device, and the controller is configured to prohibit activation of the acoustic transducer for clearing liquid from the acoustic pathway in response to sensing that the hearing device is deployed in the user's ear.
Example Ex29. The device according to any one of Ex16 to Ex28, wherein the hearing device comprises a sensor configured to detect a magnitude of the vibration, and the controller is configured to adjust activation of the acoustic transducer to increase the magnitude of the vibration.
Example Ex30. The device according to Ex29, wherein the sensor comprises one of a microphone and an inertial measurement unit.

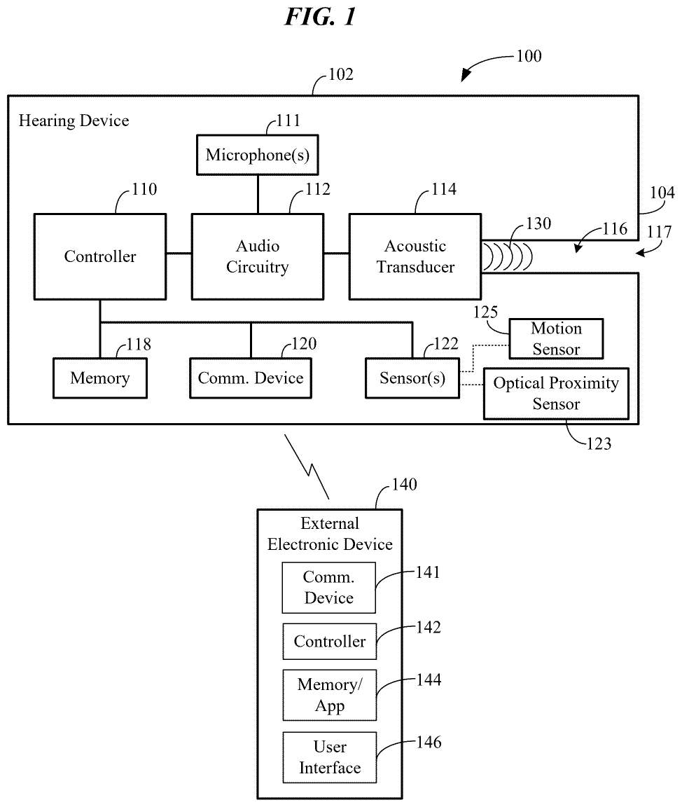

FIG. 1 is a block diagram of a representative hearing device 100 configured to implement a procedure for clearing a liquid from an acoustic pathway of the hearing device 100 in accordance with any of the embodiments disclosed herein. The hearing device 100 is representative of a wide variety of electronic devices configured to be deployed in an ear of a user. In some implementations, the hearing device 100 can be deployed in one ear of the user (e.g., left or right ear). In other implementations, a first hearing device 100 can be deployed in the user's left ear, and a second hearing device 100 can be deployed in the user's right ear. The first and second hearing devices 100 can operate cooperatively (e.g., via an inductive or radio frequency ear-to-ear link) or independently.

The term hearing device refers to a wide variety of electronic devices configured for deployment in an ear of a user. Representative hearing devices of the present disclosure include, but are not limited to, in-the-canal (ITC), completely-in-the-canal (CIC), invisible-in-canal (IIC), in-the-ear (ITE), behind-the-ear (BTE), and receiver-in-canal (RIC) type devices. Representative hearing devices of the present disclosure include, but are not limited to, hearing aids, earbuds, electronic ear plugs, personal sound amplification devices, and other ear-worn electronic appliances. Hearing devices of the present disclosure include restricted medical devices (e.g., devices regulated by the U.S. Food and Drug Administration), such as hearing aids. Hearing devices of the present disclosure include consumer electronic devices, such as consumer earbuds, consumer sound amplifiers, and consumer hearing devices (e.g., consumer hearing aids and over-the-counter (OTC) hearing devices), for example. Hearing devices of the present disclosure include waterproof hearing devices.

The representative hearing device 100 shown in FIG. 1 includes a housing 102 configured for deployment in an ear of a user. According to some embodiments disclosed herein, the housing 102 can be configured for deployment at least partially within the user's ear. For example, the housing 102 can be configured for deployment at least partially or entirely within an ear canal of the user's ear. The housing 102 can be configured for deployment at least partially within the outer ear, such as from the helix to the ear canal (e.g., the concha cymba, concha cavum) and can extend up to or into the ear canal. In some configurations, the shape of the housing 102 can be customized for the user's ear canal (e.g., based on a mold taken from the user's ear canal). In other configurations, the housing 102 can be constructed from pliant (e.g., semisoft) material which, when inserted into the user's ear canal, takes on the shape of the ear canal.

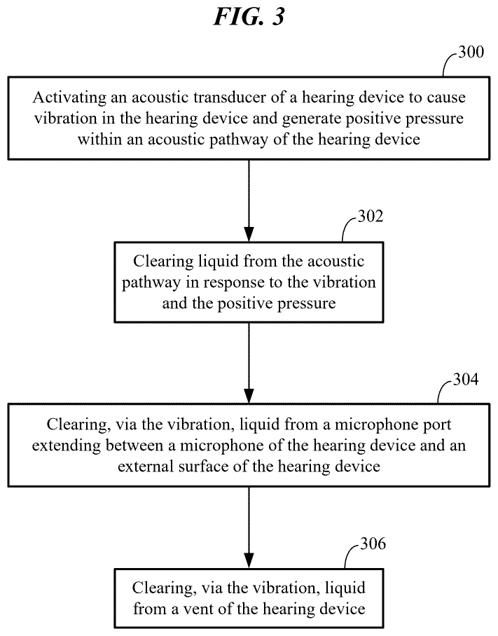

The housing 102 is configured to contain or support a number of components, a subset of which are illustrated in FIG. 1. The hearing device 100 includes a controller 110 which can include one or more processors or other logic devices. For example, the controller 110 can be representative of one or any combination of one or more logic devices (e.g., multi-core processor, digital signal processor (DSP), microprocessor, programmable controller, general-purpose processor, special-purpose processor, hardware controller, software controller, a combined hardware and software device), and/or other digital logic circuitry (e.g., ASICs, FPGAs). The controller 110 can include or be coupled to a memory 118. The memory 118 can include one or more types of memory, including ROM, RAM, SDRAM, NVRAM, EEPROM, and FLASH, for example. The memory 118 can store software/firmware which can be executed by the controller 110 to implement the functionality disclosed herein (see, e.g., FIGS. 3-7). For example, the memory 118 can store software which can be executed by the controller 110 when implementing a liquid clearing procedure of the present disclosure.

The hearing device 100 includes audio circuitry 112 coupled to the controller 110, one or more microphones 111, and an acoustic transducer 114. The audio circuitry 112 can include an analog front end configured to filter and amplify electrical signals received from the one or more microphones 111. The audio circuitry 112 can convert the microphone electrical signals from analog to digital signals so that the digital signals can be further processed and/or analyzed by the controller 110 (e.g., a DSP integral or coupled to the controller 110). The audio circuitry 112 can convert digital signals to analog signals and communicate these signals to the acoustic transducer 114. In response to the analog signals, the acoustic transducer 114 (e.g., a receiver) generates sound which can be communicated to the wearer's eardrum.

A communication device 120 of the hearing device 100 can include a radiofrequency (RF) transceiver and an antenna. For example, the communication device 120 can incorporate an antenna arrangement coupled to a high-frequency radio, such as a 2.4 GHz radio. The radio can conform to an IEEE 802.11 (e.g., WiFi®) or Bluetooth® (e.g., Bluetooth® Low Energy) specification, for example. The communication device 120 is configured to facilitate communication between the hearing device 100 and an external electronic device 140, such as a smartphone, tablet, or small computer.

The external electronic device 140 includes a communication device 141 (e.g., an IEEE 802.11 compliant radio or BLE radio) configured to communicatively couple to the communication device 120 of the hearing device 100. The external electronic device 140 includes a controller 142 coupled to memory 144 and a user interface 146. The user interface 146 can include a touch display and an audio processing facility (e.g., including a speaker and a microphone). The memory 144 is configured to store an app which, when executed by the controller 142, facilitates interaction between the user and the hearing device 100 when implementing a liquid clearance procedure by the hearing device 100.

The hearing device 100 can include one or more sensors 122. For example, the sensors 122 can include an optical proximity sensor 123 and a motion sensor 125. The optical proximity sensor 123 operates by emitting a beam of light (e.g., infrared light) and measuring the intensity of reflected light to determine the proximity of the hearing device 100 to the user's ear 101. The optical proximity sensor 123 operates as a reflective sensor that relies on reflection of the emitted light from a reflective surface, such as the user's ear. When the hearing device 100 is close to the user's ear, the intensity of the reflected light from the user's ear as measured by the optical proximity sensor 123 increases (e.g., is high). When the hearing device 100 is moved away from the user's ear (e.g., removed from the ear), the intensity of the reflected light from the user's ear is reduced (e.g., is low). A proximity signal threshold can be established to distinguish when the hearing device 100 is deployed in the user's ear and when the hearing device 100 is removed from the user's ear.

The motion sensor 125 can include one or more of accelerometers, gyros, and magnetometers. For example, the motion sensor 125 can be implemented to include a multi-axis (e.g., 9-axis) sensor, such as an IMU (inertial measurement unit). When the hearing device 100 is deployed in the user's ear, the motion sensor 125 can sense movement of the user's ear due to movement of the user's head. The motion sensor 125 can generate a sensor signal indicating the presence of movement of the user's ear, such as when the hearing device 100 is deployed in the wearer's ear. The motion sensor 125 can generate a sensor signal indicating the absence of movement of the user's ear, such as when the hearing device 100 is removed from the wearer's ear.

In some implementations, the one or more sensors 122 can include an electrical sensor configured to sense contact between the hearing device 100 and skin of the user's ear. For example, the electrical sensor can be configured to sense one or any combination of impedance, conductance, resistance, and electrodermal activity (e.g., galvanic skin response). The electrical sensor can generate a sensor signal indicating contact with the user's ear, such as when the hearing device 100 is deployed in the wearer's ear. The electrical sensor can generate a sensor signal indicating the absence of contact with the user's ear, such as when the hearing device 100 is removed from the wearer's ear.

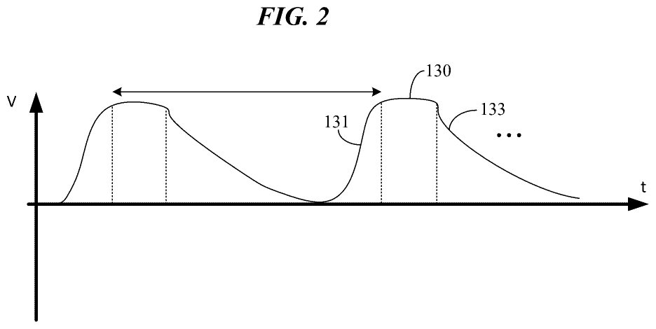

The hearing device 100 is configured to implement a procedure for clearing a liquid 132 from an acoustic pathway 116 of the hearing device 100. When implementing a liquid clearing procedure by the controller 110, and as illustrated in FIG. 1 and FIG. 2, the acoustic transducer 114, in a first transducer mode, produces sound waves 130 that generate positive pressure within the acoustic pathway 116 extending between the acoustic transducer 114 and an exterior surface 104 of the housing 102. According to some embodiments, the acoustic transducer 114 can be a receiver and the acoustic pathway 116 can be a receiver port.

The positive pressure produced within the acoustic pathway 116 by the sound waves 130 develops a force that acts on a column of liquid residing in the acoustic pathway 116. This force urges the column of liquid to move in a direction away from the acoustic transducer 114 and towards (and out of) an outlet 117 of the acoustic pathway 116. It is noted that, in some hearing devices, the acoustic pathway 116 can define a tube having a length of about 5 mm and a diameter of about 1.3 mm. The dimensions of the acoustic pathway 116 will vary depending on the design of the hearing device. According to some embodiments, the acoustic transducer 114 and acoustic pathway 116 are components of an earpiece which is connected to the housing 102 via a cable (e.g., a RIC type device).

In addition to generating positive pressure within the acoustic pathway 116, the acoustic transducer 114, in a second transducer mode, is activated to cause the hearing device 100 to vibrate. The combination of vibration and positive pressure forces liquid from the acoustic pathway 116 and out of the hearing device 100 via outlet 117. In some implementations, the acoustic transducer 114 is activated at a frequency that substantially matches a vibration resonant frequency of the hearing device 100, which enhances (e.g., maximizes) the magnitude of hearing device vibration. Causing the hearing device 100 to vibrate serves to clear liquid droplets from the acoustic pathway 116.

According to various embodiments, there can be two different resonant frequencies involved in the liquid clearing procedure. For clearing liquid from the acoustic pathway 116 using positive sound pressure, an audio resonant frequency of the acoustic transducer (e.g., receiver) that produces the sound pressure is implicated. The audio resonant frequency is dependent on the design of the acoustic transducer, and is fixed once the acoustic transducer is fabricated. For example, many hearing device receivers have an audio resonant frequency between about 1.8 kHz and 3.4 kHz.

For clearing liquid from the acoustic pathway 116 using vibration, this mechanism relies on a vibration resonance frequency of the entire hearing device. The vibration resonance frequency depends on how the hearing device is fixed. For example, the vibration resonance frequency of the hearing device will be lower when the hearing device is placed on a soft cloth situated on a table. Placing the hearing device in a hard charging unit will increase the vibration resonance frequency of the hearing device. The vibration energy increases with increasing vibration resonance frequency, which can range from about 6 kHz to about 10 kHz.

In some implementations, the audio resonant frequency of the hearing device 100 may not be known, but may be known to fall within a specified range of frequencies. The liquid clearing procedure can involve sweeping the sound waves 130 from a first frequency to a second frequency, such that at least some of the sound waves 130 have a frequency that substantially matches the audio resonant frequency of the hearing device 100. For example, the first frequency can be about 1 kHz and the second frequency can be about 4 kHz. In another example, the first frequency can be about 1 kHz and the second frequency can be about 2.5 kHz or 2.8 kHz. In a further example, the first frequency can be about 1 kHz and the second frequency can be about 2 kHz.

During the liquid clearing procedure, the acoustic transducer 114 can be activated for a specified duration and at a specified intensity. For example, the acoustic transducer 114 can be activated for a duration that ranges from about 5 seconds to about 20 seconds, such as from about 5 seconds to about 10 seconds. In some implementations, the acoustic transducer 114 can be activated at a maximum intensity (e.g., maximum voltage applied to the acoustic transducer 114).

FIG. 2 illustrates a series of sound waves 130 generated by the acoustic transducer 114 shown in FIG. 1 when implementing a liquid clearing procedure in accordance with any of the embodiments disclosed herein. The sound waves 130 can be characterized as a sequence of high pressure audio frequency pulses generally in the form of positive-going square waves. The sound waves 130 have a steep rising slope 131 and a gradual trailing slope 133. The gradual trailing slope 133 provides for slow pressure relaxation between adjacent sound waves 130.

FIG. 3 is a flow diagram of a method for clearing a liquid from a hearing device in accordance with any of the embodiments disclosed herein. The method shown in FIG. 3 is performed with the hearing device removed from the wearer's ear. The method shown in FIG. 3 involves activating 300 an acoustic transducer of the hearing device to cause vibration in the hearing device and generate positive pressure within the acoustic pathway. The method also involves clearing 302 the liquid from the acoustic pathway in response to the vibration and the positive pressure. The method can further involve clearing 304, via the vibration, liquid from a microphone port extending between a microphone of the hearing device and an external surface of the hearing device. The method can also involve clearing 306, via the vibration, liquid from a vent of the hearing device.

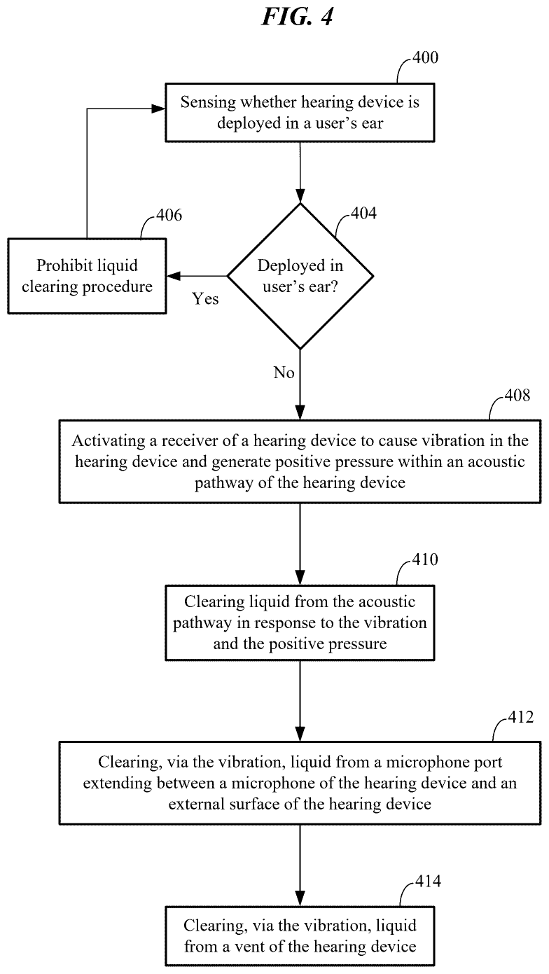

FIG. 4 is a flow diagram of a method for clearing a liquid from a hearing device in accordance with any of the embodiments disclosed herein. The method shown in FIG. 4 involves sensing 400 whether the hearing device is deployed in a user's ear. As previously discussed, an optical proximity sensor or other sensor (e.g., motion sensor, electrical contact sensor) of the hearing device can be used to sense whether or not the hearing device is positioned in the user's ear. If, at decision block 404, the hearing device is deployed in the user's ear, the liquid clearing procedure is prohibited 406, and the method returns to sensing block 400.

If, at decision block 404, the hearing device is not deployed in the user's ear, the liquid clearing procedure can commence. The liquid clearing procedure involves activating 408 an acoustic transducer of the hearing device to cause vibration in the hearing device and generate positive pressure within the acoustic pathway, and clearing 410 the liquid from the acoustic pathway in response to the vibration and the positive pressure. The method can also involve clearing 412, via the vibration, liquid from a microphone port extending between a microphone of the hearing device and an external surface of the hearing device. The method can further involve clearing 414, via the vibration, liquid from a vent of the hearing device.

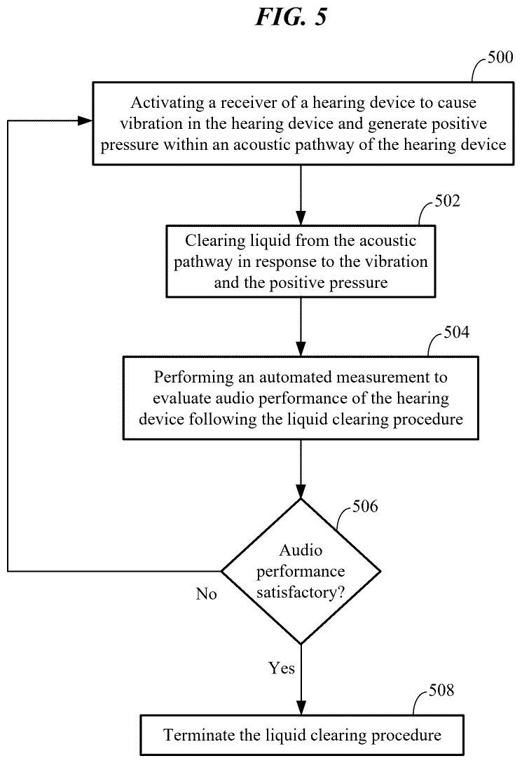

FIG. 5 is a flow diagram of a method for clearing a liquid from a hearing device in accordance with any of the embodiments disclosed herein. The method shown in FIG. 5 is performed with the hearing device removed from the wearer's ear. The method shown in FIG. 5 involves activating 500 a receiver of a hearing device to cause vibration in the hearing device and generate positive pressure within an acoustic pathway of the hearing device, and clearing 502 the liquid from the acoustic pathway in response to the vibration and the positive pressure. The method also involves performing 504 an automated measurement to evaluate audio performance of the hearing device following production of the sound waves. If, at decision block 506, audio performance is not satisfactory, method steps 500, 502, and 504 are repeated. If, at decision block 506, audio performance is satisfactory, the liquid clearing procedure is terminated 508.

According to some embodiments, performing 504 the automated measurement by the hearing device to evaluate audio performance can involve generating test tones by the receiver, capturing the test tones by a microphone, and measuring a metric of audio quality using a self-analysis procedure. The self-analysis procedure can involve capturing audio resulting from the test tones over a specified frequency range (e.g., 1 kHz to 4 kHz) and performing calculations to determine if the analyzed audio indicates that a baseline level of audio performance has been met. When the baseline level of audio performance has been met, the hearing device no longer needs to perform the liquid clearing process.

For example, the hearing device can be placed in a charger unit with the lid closed, test tones can be generated, and a sound pressure level (SPL) can be measured by the hearing device using the microphone. The measured SPL can be compared to a reference SPL stored in hearing device memory. A measured SPL that exceeds the reference SPL indicates that the acoustic pathway is not clogged by liquid. A first sound recognizable by the user can be generated by the hearing device to indicate successful clearing of the liquid from the acoustic pathway. A measured SPL that falls below the reference SPL indicates that liquid remains in the acoustic pathway. A second sound recognizable by the user can be generated to indicate that the liquid clearing procedure should be repeated, which can be implemented inside or outside of the charging unit.

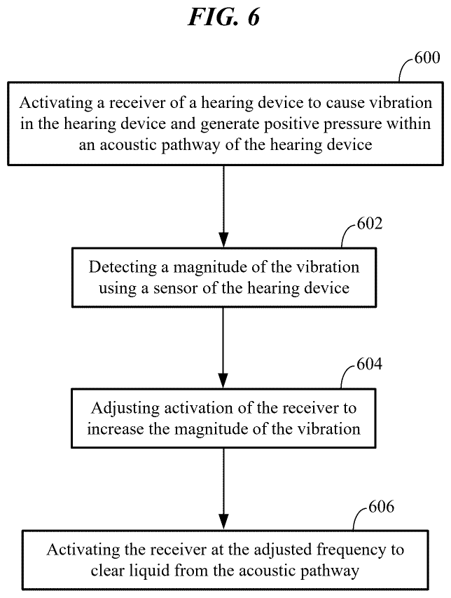

FIG. 6 is a flow diagram of a method for clearing a liquid from a hearing device in accordance with any of the embodiments disclosed herein. The method shown in FIG. 6 is performed with the hearing device removed from the wearer's ear. The method shown in FIG. 6 involves activating 600 a receiver of a hearing device to cause vibration in the hearing device and generate positive pressure within an acoustic pathway of the hearing device. The method involves detecting 602 a magnitude of the vibration using a sensor of the hearing device. In some implementations, the sensor can be a motion sensor, such as an accelerometer or IMU. In other implementations, the sensor can be the microphone of the hearing device.

The method also involves adjusting 604 activation of the receiver to increase the magnitude of the vibration. The magnitude of hearing device vibration changes in response to a change in the frequency of signals supplied to the receiver. For example, the magnitude of hearing device vibration increases as the frequency of signals supplied to the receiver approaches a vibration resonant frequency of the hearing device. A search can be performed by the hearing device to determine the frequency of signals that produce the highest magnitude of hearing device vibration. The liquid clearing procedure can be carried out 606 using the signals that produce the highest magnitude of hearing device vibration.

The frequency of signals supplied to the receiver can be adjusted within a specified frequency range (e.g., 6 kHz to 10 kHz). The vibration resonant frequency of the hearing device may not be known, but may be known to fall within the specified frequency range. The frequency of signals supplied to the receiver can be adjusted using a specified step size (e.g., 10 Hz, 50 Hz, 100 Hz). At each frequency step within the specified frequency range, the magnitude of hearing device vibration can be measured by a sensor and stored in a memory of the hearing device. After sweeping through the specified frequency range, the frequency of the receiver signals associated with the highest magnitude of vibration can be identified. The frequency of signals supplied to the receiver can be set to the frequency associated with the highest magnitude of hearing device vibration.

It is noted that the liquid clearing procedure can be conducted with the microphone(s) turned off. In some instances, causing the hearing device to vibrate can push the hearing device into instability. This can cause the hearing device to produce loud and unpleasant sound. Turning off the microphone(s) during the liquid clearing procedure avoids the production of loud and unpleasant sound. The microphone(s) can be turned on to conduct self-testing of the hearing device to evaluate the efficacy of the liquid clearing procedure.

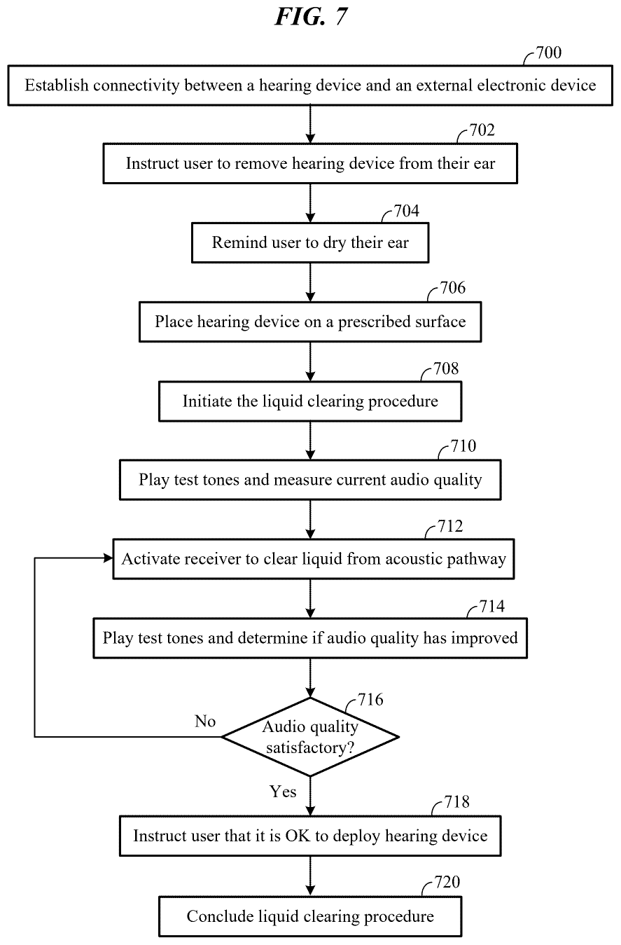

FIG. 7 is a flow diagram of a method for clearing a liquid from a hearing device in accordance with any of the embodiments disclosed herein. The method shown in FIG. 7 involves communication and interaction between the hearing device and an external electronic device, such as a smartphone, a tablet, or a small computer. Although the method shown in FIG. 7 is directed to a single hearing device, it is understood that the liquid clearing procedure can be implemented for a pair of hearing devices concurrently or sequentially.

The external electronic device can execute an app which allows the user to interact with the hearing device when implementing a liquid clearing procedure. For example, the app can generate a graphical user interface (GUI) which can receive user inputs (e.g., button taps, voice commands), produce user-perceivable outputs (e.g., textual, graphical, audio), and communicate information during implementation of the liquid clearing procedure. After launching the app by the user, the method involves establishing 700 connectivity between the hearing device and the external electronic device. The connection between the hearing device and the external electronic device can be a short-range wireless link, such as a BLE link.

A user-perceivable output is generated 702 instructing the user to remove the hearing device from their ear. A check can be made to determine whether the hearing device is deployed in the user's ear according to the method shown in FIG. 4. As previously discussed, the liquid clearing procedure is prohibited if the hearing device is deployed in the user's ear. A message can be generated reminding 704 the user to dry their ear. Drying the ear can prevent residual liquid from reentering the hearing device after completion of the liquid clearing procedure. The user can be instructed to place 706 the hearing device on a prescribed surface, such as an absorptive cloth situated on a table or counter. The user can be instructed to situate the hearing device in a specified orientation on the prescribed surface. For example, the specified orientation may cause the receiver to be pointed down towards the prescribed surface. This orientation benefits from the pull of gravity which can assist clearing of liquid from the acoustic pathway.

After placing the hearing device on the prescribed surface, the method involves initiating 708 the liquid clearing procedure (e.g., by the user pressing a start procedure button on the GUI). A series of test tones is played 710 and a metric of current audio quality is measured by the hearing device, such as in the manner described with reference to FIG. 5. Assuming liquid is present in the acoustic pathway of the hearing device, the metric of current audio quality will likely fall below a baseline metric indicating satisfactory audio quality. The receiver of the hearing device is activated 712 to clear liquid from the acoustic pathway in a manner previously described. Afterwards, test tones are played 714 and a check is made to determine if audio quality has improved. If audio quality is not satisfactory, as tested at block 716, processing blocks 712 and 714 are repeated. If, at block 716, the audio quality is satisfactory, the user is instructed 718 that it is okay to deploy the hearing device in the user's ear. The liquid clearing procedure is concluded at block 720.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The terms “connected” or “coupled” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality. Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A hearing device, comprising:
a controller comprising one or more processors;
audio circuitry coupled to the controller; and
an acoustic transducer coupled to the audio circuitry, the acoustic transducer fluidically coupled to an acoustic pathway between the acoustic transducer and an exterior surface of the hearing device;
wherein the controller is configured to activate the acoustic transducer to cause vibration in the hearing device and generate positive pressure within the acoustic pathway sufficient to clear liquid from the acoustic pathway.

2. The device according to claim 1, wherein:
the acoustic transducer is a receiver; and
the acoustic pathway comprises a receiver port extending between the receiver and the exterior surface of the hearing device.

3. The device according to claim 1, comprising:
a microphone fluidically coupled to a microphone port extending between the microphone and the exterior surface of the hearing device;
wherein the vibration in the hearing device is sufficient to clear liquid from the microphone port.

4. The device according to claim 1, wherein:
the hearing device comprises a vent; and
the vibration in the hearing device is sufficient to clear liquid from the vent.

5. The device according to claim 1, wherein the controller is configured to activate the acoustic transducer to produce sound waves comprising a series of positive-going square waves.

6. The device according to claim 5, wherein the square waves have a steep rising slope and a gradual trailing slope.

7. The device according to claim 1, wherein the controller is configured to:
activate the acoustic transducer at a first frequency that substantially matches an audio resonant frequency of the acoustic transducer to generate positive pressure within the acoustic pathway; and
activate the acoustic transducer at a second frequency that substantially matches a vibration resonant frequency of the hearing device to cause the hearing device to vibrate.

8. The device according to claim 1, wherein the controller is configured to activate the acoustic transducer for a specified duration and at a maximum intensity.

9. The device according to claim 8, wherein the specified duration ranges from about 5 seconds to about 10 seconds.

10. The device according to claim 1, wherein the controller is configured to perform an automated measurement to determine audio performance of the hearing device following activation of the acoustic transducer.

11. The device according to claim 10, wherein the controller is configured to repeat activation of the acoustic transducer until satisfactory hearing device performance is achieved.

12. The device according to claim 1, wherein:
the hearing device comprises a sensor coupled to the controller, the sensor configured to sense whether the hearing device is deployed in an ear of a user of the hearing device; and
the controller is configured to prohibit activation of the acoustic transducer for clearing liquid from the acoustic pathway in response to sensing that the hearing device is deployed in the user's ear.

13. The device according to claim 1, wherein:
the hearing device comprises a sensor configured to detect a magnitude of the vibration; and
the controller is configured to adjust activation of the acoustic transducer to increase the magnitude of the vibration.

14. The device according to claim 13, wherein the sensor comprises one of a microphone and an inertial measurement unit.

15. A method of clearing a liquid from an acoustic pathway of a hearing device, comprising:
activating an acoustic transducer of the hearing device to cause vibration in the hearing device and generate positive pressure within the acoustic pathway; and
clearing the liquid from the acoustic pathway in response to the vibration and the positive pressure.

16. The method according to claim 15, wherein:
the acoustic transducer is a receiver; and
the acoustic pathway comprises a receiver port extending between the receiver and an external surface of the hearing device.

17. The method according to claim 15, comprising producing, by the acoustic transducer, sound waves to generate positive pressure within the acoustic pathway, wherein the sound waves comprise a series of positive-going square waves and the square waves have a steep rising slope and a gradual trailing slope.

18. The method according to claim 15, wherein the acoustic transducer is:
activated at a first frequency that substantially matches an audio resonant frequency of the acoustic transducer to generate positive pressure within the acoustic pathway; and
activated at a second frequency that substantially matches a vibration resonant frequency of the hearing device to cause the hearing device to vibrate.

19. The method according to claim 15, wherein the acoustic transducer is activated for a specified duration and at a maximum intensity, the specified duration ranging from about 5 seconds to about 10 seconds.

20. The method according to claim 1, comprising:
sensing whether the hearing device is deployed in an ear of a user of the hearing device; and
prohibiting the liquid clearing method in response to sensing that the hearing device is deployed in the user's ear.
